(19) United States
(12) Patent Application Publication
(10) Pub. No.: US 2012/0032878 A1
(43) Pub. Date: Feb. 9, 2012

(54) INPUT APPARATUS USING A CONDUCTIVE RUBBER MEMBER

(76) Inventor: Eui Jin Oh, Daejeon (KR)

(21) Appl. No.: 13/265,262

(22) PCT Filed: Apr. 27, 2010
(86) PCT No.: PCT/KR10/02622

§ 371 Date: Oct. 19, 2011

(30) Foreign Application Priority Data
Apr. 27, 2009 (KR) 10-2009-0036734

(51) Int. Cl. G09G 5/00

(52) U.S. Cl. 345/156

(57) ABSTRACT

A data input apparatus using a conductive rubber member is provided. The apparatus includes a conductive rubber member, to one end of which voltage is input and though the other end of which voltage reduced in proportion to the internal resistance and the length thereof is output; a voltage output member which is brought into contact with the conductive rubber member to output the voltage value of the conductive rubber member at the contact point; and a control unit which recognizes the contact point based on the voltage value input from the voltage output member, extracts data corresponding to the contact point from a memory unit, and inputs the extracted data.

### TECHNICAL FIELD

The present invention relates to a data input apparatus using a conductive rubber member, and more particularly, to a data input apparatus using a conductive rubber member, which enables a user to input various data in a narrow space using an inexpensive conductive rubber member.

### BACKGROUND ARTS

Recently, due to the development of software, technology of, a semiconductor, and information processing technology, information devices become gradually small. In proportion, the importance of data input in various information devices has been also increased day by day.

However, many problems in an input of various characters or commands have revealed in the information devices.

For example, there is a limitation in decreasing a size of an input device, such as a keyboard used in a personal computer or a notebook computer, so there is a difficulty in miniaturizing the information devices.

Further, in a touch screen scheme used in a Personal Data Assistant (PDA) or a keypad scheme used in a mobile phone, a speed of an input is slow and there are many cases of an incorrect input, so these schemes are inconvenient.

As a mobile terminal gradually realizes a performance rivaling that of a desktop computer, there arises a situation where a mobile terminal has to be able to perform every input function of a keyboard including the input of various instruction keys (enter key, space key, shift key, etc.) and symbols, in addition to a function of an input of characters. Therefore, the inventor of the present invention had invented a data input device enabling a user to rapidly and accurately input various data in a small and narrow space.

However, in order to sense an input motion in a plurality of directions, the input device should be separately provided with a sensing means, such as a pressure sensor, a haptic sensor, or an optical sensor, for an input motion in each direction. Therefore, a conventional input device requires the costs for a sensing means and a time for the coupling of the sensing means for implementing the input device, thereby failing to reduce entire costs of the input device.

Alternatively, a scheme of detecting a signal based on a resistance value changed by pressing the conductive rubber members using the conductive rubber members was developed. However, such a prior art only detects a signal based on a load changed by a changed resistance value in each of the conductive rubber members, but fails to detect an input at a specific point in a single conductive rubber member.

Further, the data input device according to a prior art fails to perform the two or more different types of input through the conductive rubber member, so there is a limitation in inputting and processing various data.

A user can move a cursor and perform a function like pressing left and right buttons of a mouse through a conventional touch pad. However, when a user contacts or presses two or more points in the conventional touch pad, it is impossible to input a signal. Accordingly, even if a touch pad is included in a portable terminal, it is necessary to perform several times of input so as to expand or reduce an image, so it is impossible to rapidly and accurately perform various types of input in a portable terminal.

### DISCLOSURE OF INVENTION

### Technical Problems

The present invention has been made to provide a data input apparatus using a conductive rubber member, which enables a user to input various data by using a cheap conductive rubber member.

### Technical Solution

In order to achieve the foregoing and/or other aspects of the present invention, there is provided a data input apparatus including: a first conductive rubber member, to one end of which a predetermined voltage is applied and though the other end of which a voltage reduced in proportion to an internal resistance and a length thereof is output; a first voltage output member disposed in an upper side of the first conductive rubber member with being spaced apart from the first conductive rubber member and coming into contact with the first conductive rubber member according to a press of the first voltage output member at the specific point to output a voltage value of the first conductive rubber member at a specific point, so as to recognize contraction at the specific point of the first conductive rubber member; and a control unit for recognizing the specific point in the first conductive rubber member based on the voltage value output from the first voltage output member, extracting a first data corresponding to the specific point from a memory unit, and inputting the extracted first data.

There is provided a data input apparatus including: a current input/output member including a signal input unit and a plurality of signal output units, the signal input unit and the plurality of signal output units being separately formed on an upper portion thereof; a third conductive rubber member stacked on an upper portion of the current input/output member and configured to change a resistance value between the input signal unit and the output signal unit corresponding to a pressed point while being contracted due to press from an upper part thereof to change a current value output from the output signal unit; and a control unit for, when a current value within a set range is applied from the output signal unit, extracting data assigned to the output signal unit corresponding to a pressed point from a memory unit and inputting the extracted data.

There is provided a data input apparatus including: a fourth conductive rubber member having a resistance value changed according to contraction due to press from an upper side thereof at a corresponding point; a second current output member disposed in a lower side of the fourth conductive rubber member and coming into contact with the fourth conductive rubber member to output a current value output through the fourth conductive rubber member; and a control unit for comparing a current value output from the second current output member with a set current value to determine a contact point or a pressed point or a press strength, extracting a first data or a second data corresponding to the contact point or the pressed point and the press strength from a memory unit, and inputting the extracted first data or second data.

### Advantageous Effects

Accordingly, the data input apparatus using the conductive rubber member according to the present invention enables a user to input various data by using a cheap conductive rubber member, so that it is possible to rapidly and accurately input various data in a small and narrow space, as well as notably decrease the manufacturing costs of a data input apparatus used in a portable terminal.

Further, the data input apparatus using the conductive rubber member according to the present invention makes it possible to perform a multi-touch input for recognizing an input at multiple points using the conductive rubber member, so that a user can conveniently operate various contents displayed on a display unit of a portable terminal.

### BRIEF DESCRIPTION OF THE DRAWINGS

The objects, features and advantages of the present invention will be more apparent from the following detailed description in conjunction with the accompanying drawings, in which:

FIG. 1 is a perspective view schematically illustrating a portable terminal including a data input apparatus using a conductive rubber member according to a first embodiment of the present invention;

FIG. 2 is a sectional view taken along line A-A′ of FIG. 1;

FIG. 3 is an exploded perspective view illustrating the data input apparatus using the conductive rubber member according to the first embodiment of the present invention;

FIGS. 4 to 11 are views illustrating a signal detection method in the data input apparatus using the conductive rubber member according to the first embodiment of the present invention;

FIG. 12 is a view conceptually illustrating an example of an arrangement of each indication point in the data input apparatus using the conductive rubber member according to the first embodiment of the present invention;

FIGS. 13 and 14 are views illustrating an example of an input method in the data input apparatus using the conductive rubber member according to the first embodiment of the present invention;

FIG. 15 is a perspective view schematically illustrating a portable terminal including a data input apparatus using a conductive rubber member according to a second embodiment of the present invention;

FIG. 16 is an exploded view illustrating the data input apparatus using the conductive rubber member according to the second embodiment of the present invention;

FIG. 17 is a view illustrating a data input in the data input apparatus using the conductive rubber member according to the second embodiment of the present invention;

FIG. 18 is a sectional view taken along line B-B′ of FIG. 17;

FIG. 19 is an exploded view illustrating a data input apparatus using a conductive rubber member according to a third embodiment of the present invention; and

FIGS. 20 to 22 are sectional views illustrating the data input apparatus using the conductive rubber member according to the third embodiment of the present invention.

### EMBODIMENTS OF INVENTION

Hereinafter, the embodiment of the present invention will be described in detail with reference to the accompanying drawings so that those skilled in the art may easily perform the present invention. In the drawings, in order to clearly describe the present invention, parts that are not related to description are omitted and similar elements are denoted by similar reference numerals throughout the specification.

Throughout the specification, when an element is referred to as “being included”, unless there is anything particularly written to the contrary, it means that other elements are not excluded but may be further included.

In addition, the terms of ‘ . . . module’ and ‘ . . . unit’ written in the specification mean units for processing at least one function or operation and may be realized by hardware, software, or a combination of hardware and software.

The present invention relates to a data input apparatus using a conductive rubber member, and more particularly, to a data input apparatus using a conductive rubber member, which enables a user to perform a multi-touch input, thereby making it possible to input various input and recognize inputs at a plurality of points.

Hereinafter, a data input apparatus using a conductive rubber member according to preferred embodiments of the present invention will be described with accompanied drawings in detail.

### First Embodiment

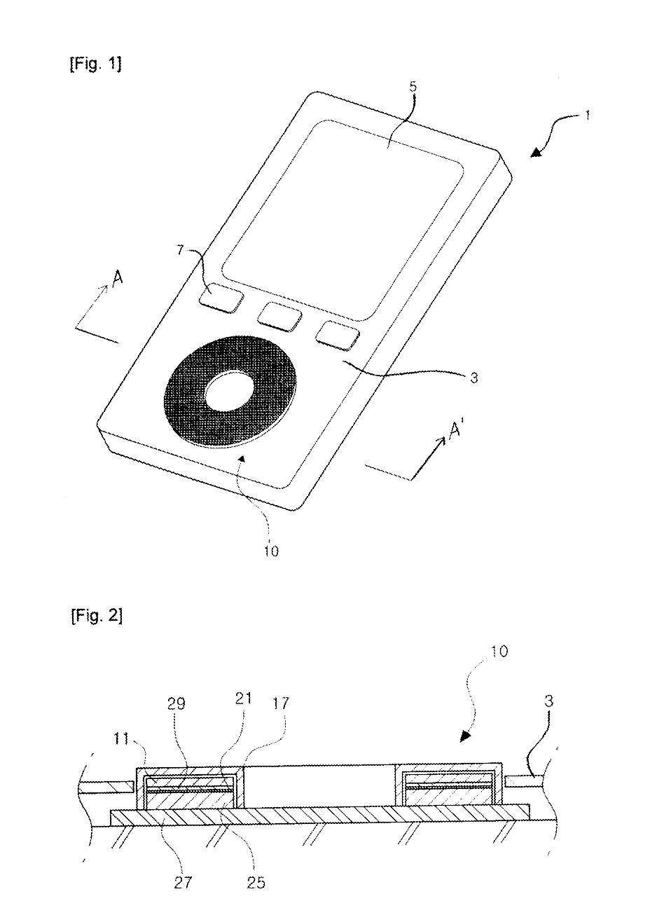

Referring to FIG. 1, a data input apparatus 10 using a conductive rubber member according to a first embodiment of the present invention may be used in a portable terminal 1 which includes a display unit 5 and various function keys 7 at one side of a base 3. The data input apparatus 10 using the conductive rubber member may be used any device, such as a desktop computer and a notebook computer, employing an input device, in addition to the aforementioned portable terminal 1. The data input apparatus 10 using the conductive rubber member may be integrally formed with the portable terminal 1 as shown in FIG. 1, or separately formed and connected to the portable terminal 1 through an USB or a cable in a wired manner or through various disclosed wireless transmission schemes in a wireless manner. A method of connecting the separately formed data input apparatus 10 using the conductive rubber member to the portable terminal 1 is apparent to those skilled in the art, so its detailed description will be omitted. The separately formed data input apparatus 10 using the conductive rubber member may be connected to various devices using an input device for use, in addition to the portable terminal 1. For the help of understanding of the invention and the convenience of description, the integral data input apparatus using the conductive rubber member will be described.

As illustrated in FIGS. 2 to 5, the data input apparatus 10 using the conductive rubber member according to the first embodiment of the present invention includes a first conductive rubber member 11, a first voltage input line 13, a first voltage output line 15, a first voltage output member 17, a first detection line 19, a second conductive rubber member 25, a potential setting member 21, a first current output member 27, a first substrate 28, an insulation member 29, and a control unit (not shown).

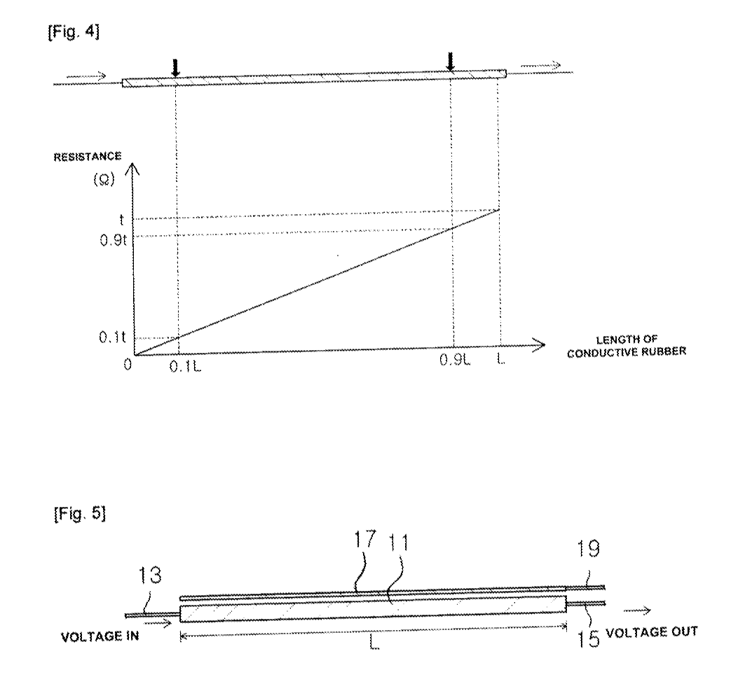

As illustrated in FIG. 4, the data input apparatus 10 using the conductive rubber member according to the first embodiment of the present invention uses a feature that a resistance value increases according to an increase of a length of the conductive rubber member. Accordingly, if a voltage applied to the conductive rubber member is measured based on a difference of a resistance value according to a length of the conductive rubber member, it is possible to detect a pressed point of the conductive rubber member. That is, it is possible to identify a contact point at the conductive rubber member.

For example, on an assumption that a length of the conductive rubber member is L and a resistance value for an entire length L is t(Ω), a length is in proportion to a resistance value, so that a resistance value for the length 0.1 L is 0.1 t(Ω), and a resistance value for the length 0.9 L is 0.9 t(Ω). Such a result can be predicted from a physical feature having a unique resistance value. By using such property of the conductive rubber member, the present invention identifies a contact point at the conductive rubber member.

The conductive rubber member of the present invention has a property of resiliently deformed rubber. If the conductive rubber member is pressed, the conductive rubber member is deformed, but a power applied to the rubber member is released, the conductive rubber member returns to an original state according to the resilient deformation property of rubber.

Hereinafter, a method of determining a contact point through press of the conductive rubber member will be described.

As illustrated in FIG. 5, the first voltage input line 13 for applying a predetermined voltage is connected to one end of the first conductive rubber member 11 and the first voltage output line 15 is connected to an opposite end of the first conductive rubber member 11. In this case, a voltage value output through the first voltage output line 15 is a voltage value reduced in proportion to an internal resistance and a length of the first conductive rubber member.

The first voltage output member 17 is installed in an upper side of the first conductive rubber member 11 and the first detection line 19 for outputting a voltage applied to the first voltage output member 17 to the outside is connected to one end of the first voltage output member 17. It is preferred that a specific resistance of the first voltage output member 17 is considerably smaller than that of the first conductive rubber member 11 such that a voltage output from a contact point of the first conductive rubber member 11 is output through the first voltage output member 17 when the first voltage output member 17 is in contact with the first conductive rubber member 11. The first voltage output member 17 is made of a conductive material such that the first voltage output member 17 comes into contact with the first conductive rubber member 11 to output a voltage output from the first conductive rubber member 11 at the contact point.

The first voltage output member 17 may further include a non-conductive member (not shown) on an upper portion thereof for preventing a voltage or current flowing a body of a user from flowing through the first voltage output member 17 when the user presses the first voltage output member 17. The non-conductive member (not shown) and the conductive member included in the first voltage output member 17 may be integrally formed with each other through a double injection molding or separately formed and then coupled to each other.

When a specific point of the first voltage output member 17 is pressed so that the first voltage output member 17 comes into contact with the first conductive rubber member 11, a voltage output from the first conductive rubber member 11 at the contact point is output through the first detection line 19 connected to the first voltage output member 17 and the control unit (not shown) recognizes the contact point based on the voltage value output through the first detection line 19. When a power applied to the first voltage output member 17 is released, the first voltage output member 17 returns to an original position and state. The first voltage output member 17 may return to an original position and state using its resiliency or be restored through an additionally included return member (not shown) which makes the first voltage output member 17 return to an original position. It is apparent to those skilled in the art that the return member (not shown) which makes the first voltage output member 17 return to an original position may be made of various materials including resilient materials, such as a spring, a magnet, silicon, and be formed in various shapes, to make the first voltage output member 17 return to an original position.

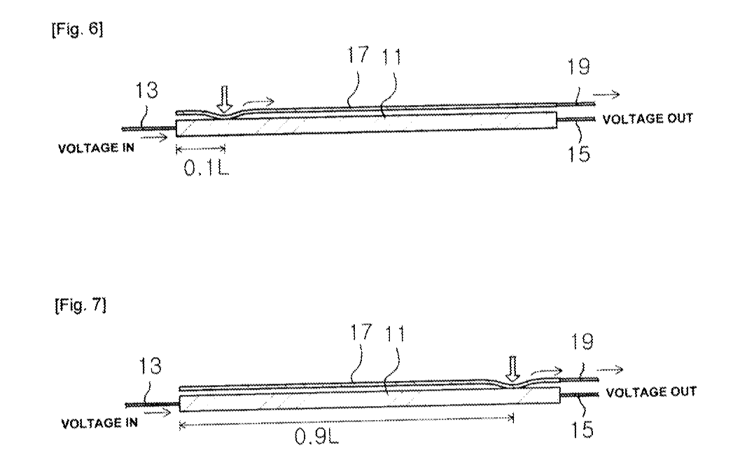

For example, as illustrated in FIG. 6, when a user presses the first voltage output member 17 at 0.1 L among the entire length L of the first conductive rubber member 11, the first voltage output member 17 comes into contact with the first conductive rubber member 11 while being deformed and a voltage applied to the first conductive rubber member 11 output through the first voltage output member 17 is detected by the first detection line 19. Accordingly, if a voltage applied through the first voltage input line 13 connected to the one end of the first conductive rubber member 11 is V, a voltage output through the first detection line 19 is approximately 0.9 V. Therefore, the control unit (not shown) recognizes that a point in the first voltage output member 17 indicated with a white arrow of FIG. 6 is pressed based on the voltage value output through the first detection line 19.

For another example, as illustrated in FIG. 7, when a user presses the first voltage output member 17 at 0.9 L among the entire length L of the first conductive rubber member 11, the first voltage output member 17 comes into contact with the first conductive rubber member 11 while being deformed and a voltage applied to the first conductive rubber member 11 output through the first voltage output member 17 is detected by the first detection line 19. Accordingly, if a voltage applied through the first voltage input line 13 connected to the one end of the first conductive rubber member 11 is V, a voltage output through the first detection line 19 is approximately 0.1 V. Therefore, the control unit (not shown) recognizes that a position in the first voltage output member 17 indicated with a white arrow of FIG. 7 is pressed based on the voltage value output through the first detection line 19.

Next, a method of determining a press strength through the conductive rubber member will be described in detail.

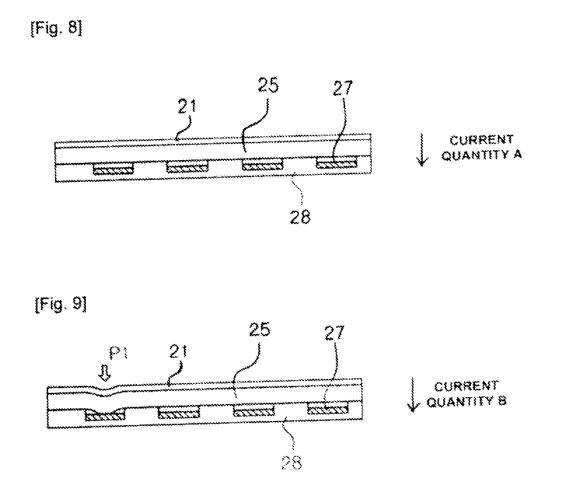

As illustrated in FIG. 8, the potential setting member 21 is installed on an upper portion of the second conductive rubber member 25 and the first current output member 27 is installed on a lower portion of the second conductive rubber member 25. In this case, it is preferred that the potential setting member 21 and the first current output member 27 have a potential difference equal to or larger than a set voltage therebetween. That is, for example, a voltage having a predetermined potential value is applied to the potential setting member 21, and a ground value is set in the first current output member 27. In this case, the first current output member 27 may be formed at only a part of the first substrate 28.

When the potential setting member 21 is pressed, the potential setting member 21 and the second conductive rubber member 25 are concavely contracted to come into contact with the first current output member 27 and a current is output through the first current output member 27. The current value output through the first current output member 27 is a current value in a state where a predetermined potential value input to the first potential setting member 21 is reduced by an internal resistance and a thickness of the second conductive rubber member 25.

For example, as illustrated in FIG. 9, when the potential setting member 21 is pressed with a predetermined pressure, the potential setting member 21 and the second conductive rubber member 25 are concavely contracted while being resiliently deformed. Accordingly, current value B output through the first current output member 27 is different from current value A output through the first current output member 27 in a state of FIG. 8.

As illustrated in FIG. 10, when the potential setting member 21 is more strongly pressed, the potential setting member 21 and the second conductive rubber member 25 are concavely contracted while being further resiliently deformed. Accordingly, current value C output through the first current output member 27 in a state of FIG. 10 is different from current value A and current value B output through the first current output member 27 in the states of FIGS. 8 and 9.

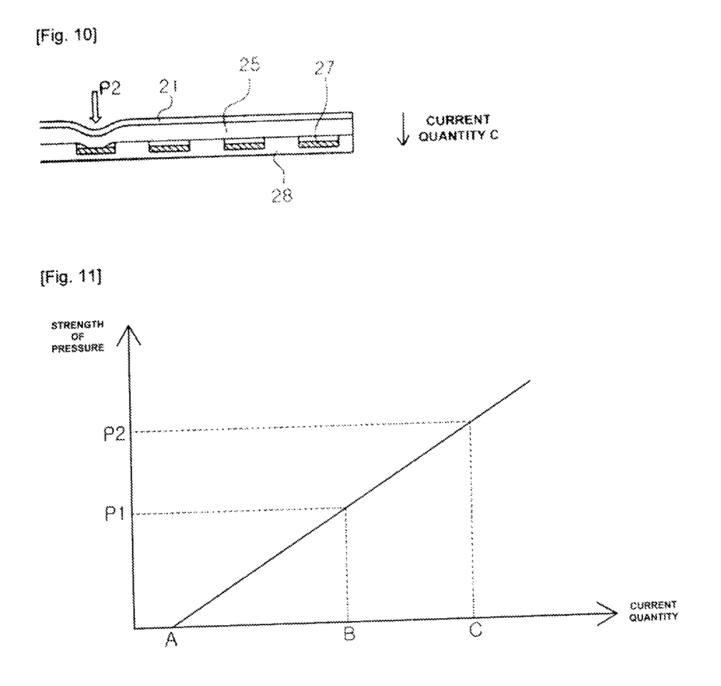

The increase or decrease of a current value from the state of FIG. 8 to the FIG. 10 depends on a feature of the second conductive rubber member 25. For example, if a resistance is decreased as the second conductive rubber member 25 is concavely contracted, the current value becomes A<B<C as illustrated in FIG. 11.

The control unit (not shown) recognizes a size of a pressure applied to the second conductive rubber member 25 through a difference of the current output from the first current output member 27.

The insulation member 29 for intercepting electric flow between the potential setting member 21 and the first conductive rubber member 11 is inserted between the potential setting member 21 and the first conductive rubber member 11. The insulation member 29 serves to prevent the voltage input to the first conductive rubber member 11 from being output through the potential setting member 21, not the first voltage output member 17, or the voltage input to the potential setting member 21 from being output through the first conductive rubber member 11.

When the second conductive rubber member 25 is pressed, the first conductive rubber member 11 is also pressed so that a voltage value of the first conductive rubber member 11 at a corresponding point outputs through the first voltage output member 17. In this case, the present invention is preferably designed such that when it is detected that a change of the current value output through the first current output member 27 due to the generation of the press to the second conductive rubber member 25 is within a set range, the input to the first current output member 27 is ignored.

In order to prevent the second conductive rubber member 25 from easily coming into contact with the first current output member 27, a non-conductive member (not shown) may be inserted between the second conductive rubber member 25 and the first current output member 27. The non-conductive member (not shown) does not completely prevent the second conductive rubber member 25 from easily coming into contact with the first current output member 27, but prevents the second conductive rubber member 25 from being in easy contact with the first current output member 27. By lowering a height at which the first current output member 27 is installed on the first substrate 28, it is possible to prevent the second conductive rubber member 25 from being in easy contact with the first current output member 27. A power strength applied to the potential setting member 21 such that the second conductive rubber member 25 comes into contact with the first current output member 27 is different depending on a thickness, a material, and a property of the non-conductive member (not shown) and a height at which the first current output member 27 is installed on the first substrate 28.

A shape of each of the aforementioned member may have a ring shape as shown in FIG. 1, or has various shapes including a straight line, a triangle, and a quadrangle. For convenience's sake, the ring-shaped member shown in FIG. 1 will be described hereinbelow.

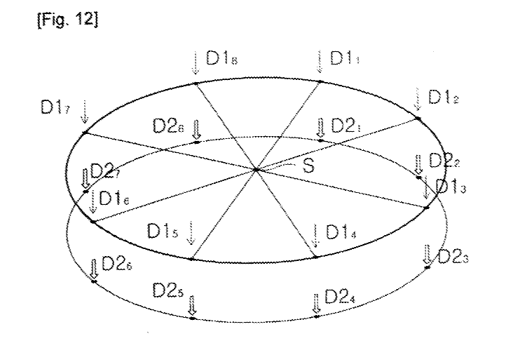

As illustrated in FIG. 12, a plurality of first indication points D1₁, D1₂, D1₃, . . . are radially arranged in the first conductive rubber member 11 at an equal interval based on reference position S, and a plurality of second indication points D2₁, D2₂, D2₃, . . . are radially arranged in the second first conductive rubber member 25 at an equal interval based on reference position S. The number and the positions of the first indication points D1₁, D1₂, D1₃, . . . may be different from or the same as those of the second indication points D2₁, D2₂, D2₃, . . . . Different first data are assigned to the first indication points D1₁, D1₂, D1₃, . . . , and different second data are assigned to the second indication points D2₁, D2₂, D2₃, . . . .

It is preferred that the second conductive rubber member 25 is formed to be thick because a resistance value of the second conductive rubber member 25 in a contracted state according to the change of a pressure applied to the second conductive rubber member 25 can be discriminated from that of the second conductive rubber member 25 at a usual time. A thickness of the second conductive rubber member 25 is not limited to a specific value, and if the thickness of the second conductive rubber member 25 is enough to discriminate a resistance value in a concavely contracted state of the second conductive rubber member 25 from that at a usual time, the second conductive rubber member 25 may be formed in various thicknesses depending on a working environment and a selection of a person skilled in the art.

Hereinafter, a method of inputting data using the data input apparatus using the conductive rubber member according to the first embodiment of the present invention will be described in detail.

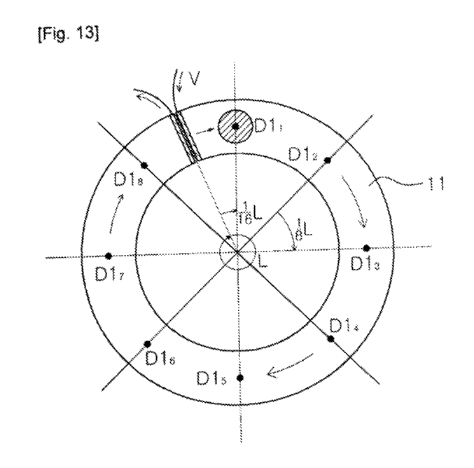

As illustrated in FIG. 13, when the first voltage output member 17 is pressed at a point corresponding to the first indication point D1₁, the first voltage output member 17 comes into contact with the first conductive rubber member 11 and a voltage value of the first indication point D1₁ of the first conductive rubber member 11 is output through the first detection line 19 via the first voltage output member 17. That is, when a voltage value V is applied to the first conductive rubber member 11 through the first voltage input line 13, a length of the first conductive rubber member 11 is L, and the first indication point D1₁ is spaced apart from the first voltage input line 13 by a distance of 1/16 L for the entire length L of the first conductive rubber member 11, a voltage value of 15/16V is output from the first detection line 19 due to an influence of the resistance value described with reference to FIG. 4.

For another example, when the first indication point D1₃ in the 3 o'clock direction is pressed, the first indication point D1₃ in the 3 o'clock direction is spaced apart from the first voltage input line 13 by ( 1/16+⅛+⅛)·L, so that a voltage value 11/16 V is output through the first voltage output member 17.

Then, the second conductive rubber member 25 may be concavely contracted due to the press to the first indication point D1₁ and thus a current value output through the first current output member 27 may be changed. In this case, if a change of the current value is not within the preset range, the control unit (not shown) determiners that the press to the first indication point D1₁ is the contact to the first indication point D1₁ so that it extracts a first data corresponding to the first indicate point D1₁ from a memory unit and inputs the extracted first data.

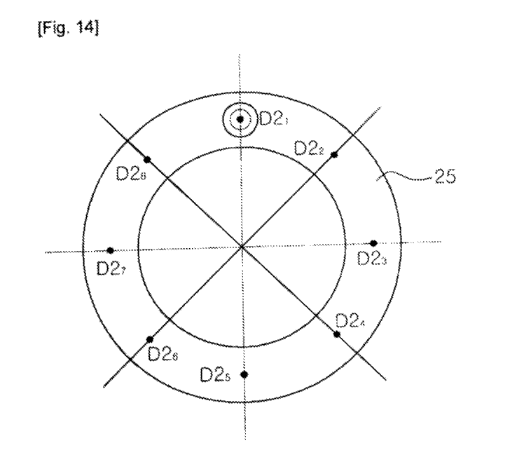

As illustrated in FIG. 14, when the second conductive rubber member 25 is concavely contracted due to the press (with a pressure larger than that of the above case) to the first indication point D1₁ so that a value change of a current output through the first current output member 27 is within the preset range, the control unit (not shown) determines that the press to the first indication point D1₁ is the press to the second indication point D2₁ located in a lower part of the corresponding first indication point D1₁. Accordingly, the control unit (not shown) extracts a second data corresponding to the second indicate point D2₁ from the memory unit and inputs the extracted second data.

When the change of the current value output through the first current output member 27 exceeds the preset range, the control unit (not shown) determines that the second indication points D2₁, D2₂, D2₃, . . . are pressed, but may make a process such that other data different from data assigned to the conventional second indication points D2₁, D2₂, D2₃, . . . are input. That is, the press to the second indication points D2₁, D2₂, D2₃, . . . may be processed with a value of a multi-stage input including at least two stages depending on the change of the current value output through the first current output member 27.

The positions and the number of first indication points D1₁, D1₂, D1₃, . . . and second indication points D2₁, D2₂, D2₃, . . . , the type of data to be assigned to the first indication points D1₁, D1₂, D1₃, . . . and the second indication points D2₁, D2₂, D2₃, . . . , and a range of a current value for a multi-stage input for the second indication points D2₁, D2₂, D2₃, . . . can be set through various S/W programming written with C Language, JAVA, MFC, Labview, Delphi, etc. The programming is not limited to C Language, JAVA, MFC, Labview, and Delphi, and various application programs may be used. It is apparent to those skilled in the art that the positions and the number of first indication points D1₁, D1₂, D1₃, . . . and second indication points D2₁, D2₂, D2₃, . . . , the type of data assigned to the first indication points D1₁, D1₂, D1₃, . . . and the second indication points D2₁, D2₂, D2₃, . . . , and a range of a value of a current of the second indication points D2₁, D2₂, D2₃, . . . for the multi-stage input can be variously set depending on a working environment and a selection of a user, so their detailed description will be omitted.

In the meantime, the first voltage output member 17 that is the element of the data input apparatus using the conductive rubber member according to the first embodiment of the present invention may be formed in various shapes, such as a quadrangle-like shape (square or rectangle), a trapezoid-like shape, or an inverted trapezoid-like shape. Such structure makes it advantageously possible that the data input apparatus with a lower height compared to a conventional data input apparatus can be designed.

The data input apparatus using the conductive rubber member according to the first embodiment of the present invention may further include various elements in addition to the aforementioned elements to as to implement the data input apparatus, and some of elements among the aforementioned elements may be omitted for the implementation of the data input apparatus.

The first conductive rubber member 11 and the second conductive rubber member 25 of the data input apparatus using the conductive rubber member according to the first embodiment of the present invention may be formed of a conductive rubber only, a combination of a conductive rubber and a conductive material, or a carbon material only. The material of the first conductive rubber member 11 and the second conductive rubber member 25 is apparent to those skilled in the art, so that its detailed description will be omitted.

### Second Embodiment

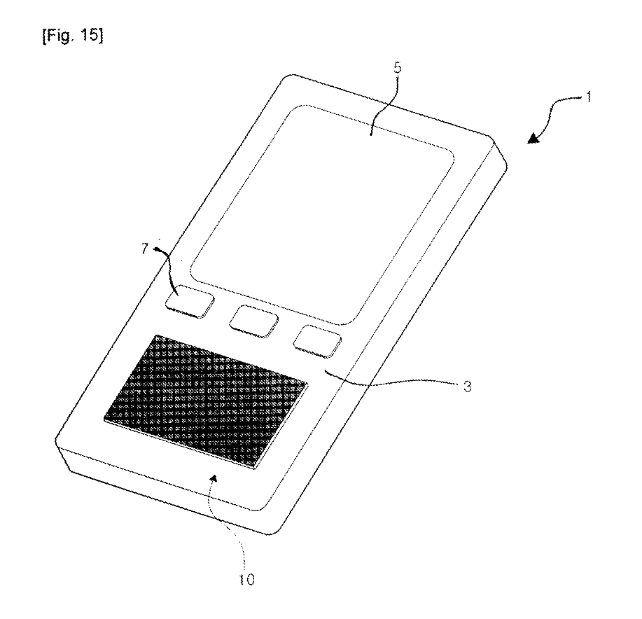

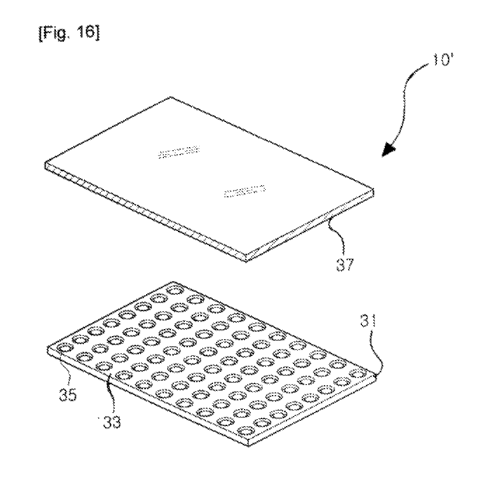

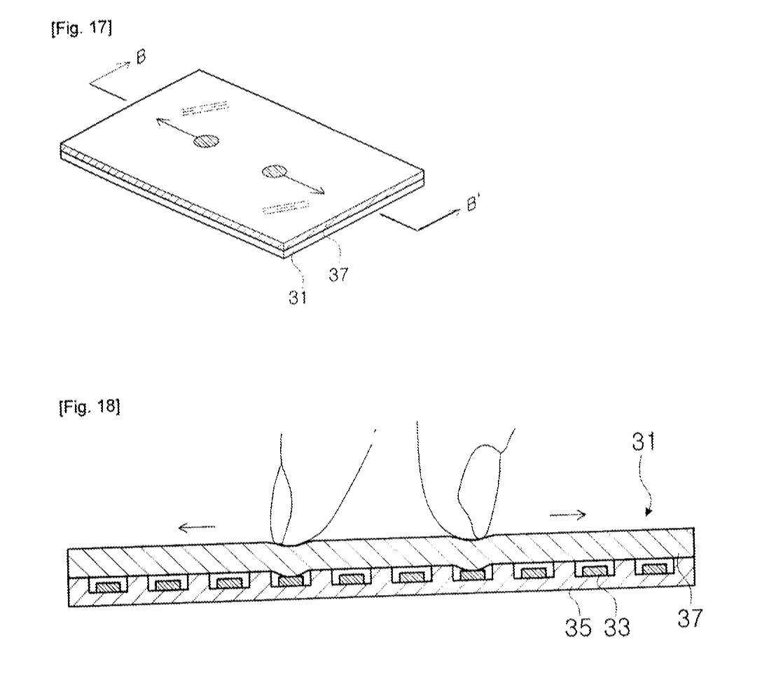

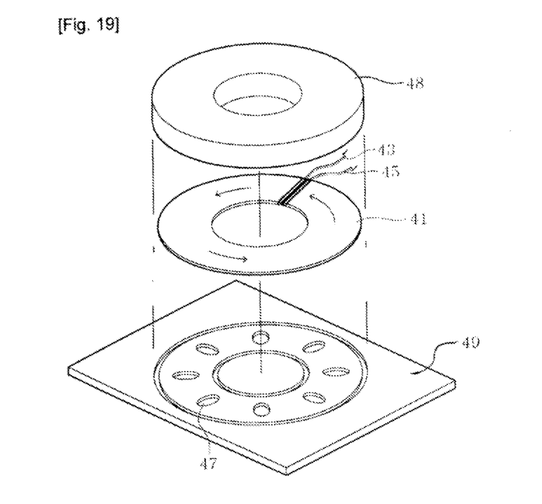

Hereinafter, a data input apparatus using a conductive rubber member according to a second embodiment of the present invention will be described with reference to FIGS. 15 to 18 in detail.

The data input apparatus 10 using the conductive rubber member according to a second embodiment of the present invention may be integrally formed with a portable terminal 1 as shown in FIG. 15, or separately formed and connected to the portable terminal 1 through an USB or a cable in a wired manner or in accordance with various wireless communication standards in a wireless manner. The data input apparatus 10 using the conductive rubber member may be integrally formed with any device using a data input device, in addition to the portable terminal 1 or separately formed and connected to any device.

The data input apparatus 10 using the conductive rubber member according to the second embodiment of the present invention includes a current input/output member 31, a third conductive rubber member 37, and a control unit (not shown).

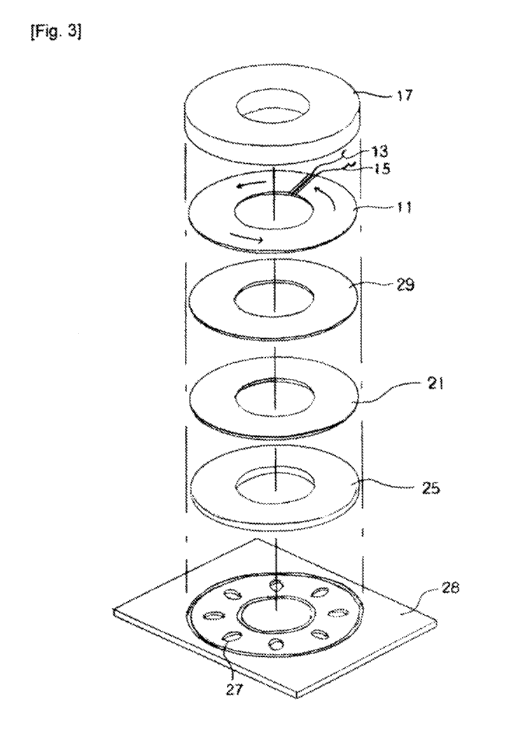

A signal input unit 33 and a plurality of signal output units 35 are separately formed on an upper portion of the current input/output member 31. The signal output units 35 may be arranged in the signal input unit 33 in a matrix shape or in a ring shape as shown in FIG. 3. The signal output units 35 may be arranged in the signal input unit 33 in various shapes, in addition to the matrix shape and the ring shape. Further, the signal output units and the signal input unit 33 may be conversely arranged.

The third conductive rubber member 37 is stacked on an upper portion of the current input/output member 31, and serves to change a resistance value between the signal input unit 33 and the signal output unit 35 corresponding to a pressed point while being concavely contracted by press from an upper side, to change a current value output from the signal output unit 35.

When the resistance value decreases while the third conductive rubber member 37 is concavely contracted, a current value output through the signal output unit 35 will be increased. In this case, the control unit (not shown) detects the increase of the current value output through the signal output unit 35 and recognizes that a specific point of the third conductive rubber member 37 corresponding to the corresponding signal output unit 35 is pressed. That is, a current value within a set range is applied from the signal output unit 35, the control unit (not shown) extracts data assigned to the signal output unit 35 corresponding to the pressed point from the memory unit and input the extracted data.

Accordingly, for example, the press of the third conductive rubber member 37 at a point corresponding to a contents menu selectable on the display unit 5 may generate an effect of the selection of the contents menu. Further, it is possible to move a cursor on the display unit 5 or input data, such as characters, when a character/command display unit displaying inputtable characters/commands is displayed on the display unit 5.

A degree of the concave contraction of the third conductive rubber member 37 is be different depending on a strength of a power applied to the third conductive rubber member 37 and a current value output through the signal output unit 35 may be different depending on a strength of the power applied to the third conductive rubber member 37. As such, if a current value output from the signal output unit 35 is different depending on a size of a power applied to the third conductive rubber member 37, the control unit (not shown) can input various data according to the current value output from the signal output unit 35. That is, it is possible to perform a multi-stage input including at least two stages depending on a size of a power applied to the third conductive rubber member 37. It is apparent to those skilled in the art that a range of a current value output from the signal output unit 35, which determines the multi-stage input, is not limited to a specific value, but may be variously set depending on their working environment or use and selection in design.

The data input apparatus 10 using the conductive rubber member according to the second embodiment of the present invention makes it possible to multi-touch input at multiple points. That is, multiple points of the third conductive rubber member are simultaneously or almost simultaneously pressed. When the multiple points of the third conductive rubber member 37 are simultaneously or almost simultaneously pressed, current values of the signal output units in lower sides of the multiple points are increased. The control unit (not shown) detects the increase of the current values of the signal output units 35 and recognizes that the multiple points have been pressed.

When the pressed points are changed after the multiple points of the third conductive rubber member 37 are simultaneously or almost simultaneously pressed, the control unit (not shown) recognizes the change of the pressed points based on the current values of the signal output units 35 corresponding to the changed points. The control unit (not shown) makes it possible to perform a movable input by which pressed points are concentrated or dispersed after the multiple points are simultaneously or almost simultaneously pressed through a current value of the signal output unit 35. For example, when a user presses two points of the third conductive rubber member 37 corresponding to both opposite ends of an image displayed on the display unit 5 and then pulls the two pressed points so as to concentrate the two points, the image is contracted and displayed. Otherwise, when a user disperses the two pressed points in opposite directions, the image is enlarged and displayed.

The data input apparatus 10 using the conductive rubber member according to the second embodiment of the present invention makes it possible to multi-touch input of recognizing the input at multiple points, so that a user conveniently operate various contents menu displayed on the display unit 5.

### Third Embodiment

Hereinafter, a data input apparatus using a conductive rubber member according to a third embodiment of the present invention will be described with reference to FIGS. 19 to 22 in detail.

Likewise to the aforementioned first and second embodiments, the data input apparatus 10 using the conductive rubber member according to the third embodiment of the present invention may be integrally formed with or separately formed from a device using a data input device.

As illustrated in FIG. 19, the data input apparatus 10 using the conductive rubber member according to the third embodiment of the present invention includes a fourth conductive rubber member 41, a second current output member 47, a second voltage output member 48, and a control unit (not shown).

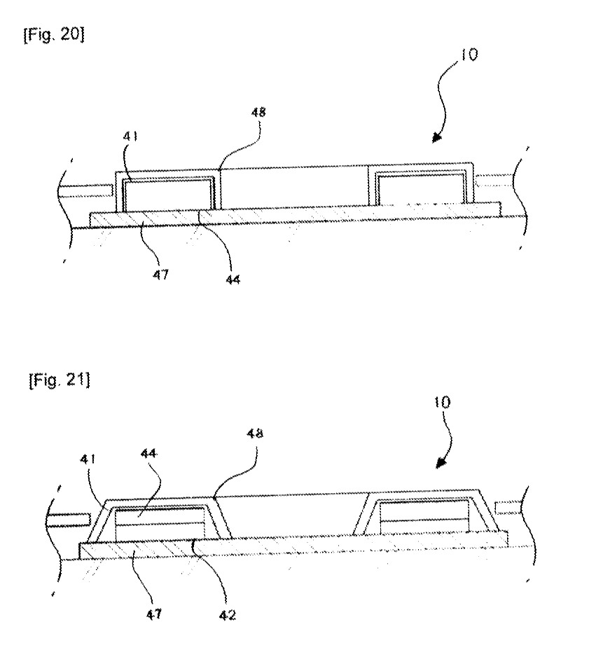

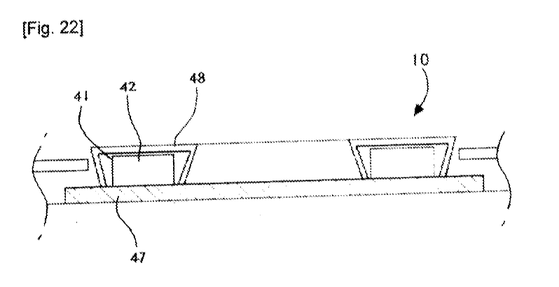

The second voltage output member 48 may have a quadrangle-like shape (square or rectangle) as shown in FIG. 20, a trapezoid-like shape as shown in FIG. 21, or an inverted trapezoid-like shape as shown in FIG. 22. As illustrated in FIG. 20, when the second voltage output member 48 is shaped like a quadrangle, an angle between the sides of the quadrangle is approximately 90°. As illustrated in FIGS. 21 and 22, when the second voltage output member 48 is shaped like a trapezoid or an inverted trapezoid, the internal angles of the trapezoid or the inverted trapezoid are not limited to a specific angle and may have various angles enough to form the trapezoid or the inverted trapezoid.

The fourth conductive rubber member 41 shown in FIG. 19 may include a single layer formed of conductive rubber only or a carbon containing conductive particles, as illustrated in FIG. 20, or include two layers (42, 44) in which conductive rubber is combined with a carbon film as illustrated in FIG. 21. As illustrated in FIG. 21, the fourth conductive rubber member 41 may include a conductive rubber layer 44 formed of conductive rubber and a carbon layer 42 formed of a carbon film. When the fourth conductive rubber member 41 may include the conductive rubber layer 44 and the carbon layer 42, the conductive rubber layer 44 and the carbon layer 42 may be integrally formed through a method, such as a double injection molding, or separately formed and then coupled to each other. A method of manufacturing the conductive rubber layer 44 and the carbon layer 42 is beyond the scope of the present invention, so its description will be omitted for convenience's sake. In the above description, the fourth conductive rubber member 41 formed by a combination of conductive rubber and carbon has been described, but any particle having a conductivity, in addition to carbon, may be mixed with conductive rubber so as to form the fourth conductive rubber member 41. Further, as illustrated in FIG. 22, the fourth conductive rubber member 41 may include the carbon layer 42 only formed of the carbon film.

Hereinafter, an example of the input apparatus including the fourth conductive rubber member 41 including either the conductive rubber layer 44 or the carbon layer 42 will be described in detail.

A second voltage input line 43 for applying a voltage having a predetermined potential value to the fourth conductive rubber member 41 is connected to one end of the fourth conductive rubber member 41 including either the conductive rubber layer 44 or the carbon layer 42, and a second voltage output line 45 for outputting a voltage output from the fourth conductive rubber member 41 is connected to an opposite end of the fourth conductive rubber member 41.

The second current output member 47 is disposed on a lower side of the fourth conductive rubber member 41 and the second voltage output member 48 is disposed on an upper side of the fourth conductive rubber member 41.

When a specific point of the second voltage output member 48 is pressed, the second voltage output member 48 is concavely contracted, so that the second voltage output member 48 comes into contact with the fourth conductive rubber member 41. The second voltage output member 48 outputs a voltage value output from the fourth conductive rubber member 41 at a corresponding contact point. The control unit (not shown) identifies the contact point based on a corresponding voltage value output from the second voltage output member 48 and extracts a first data corresponding to the contact point from the memory unit and inputs the extracted first data.

When a user presses a specific point of the second voltage output member 48, the control unit (not shown) recognizes a contact point according to the contact between the second voltage output member 48 and the fourth conductive rubber member 41. In this case, the fourth conductive rubber member 41 may come into contact with the second current output member 47. Accordingly, the control unit (not shown) may be designed such that a current value output from the second current output member 47 within a predetermined range is ignored.

When a specific point of the second voltage output member 48 is pressed, the second voltage output member 48 and the fourth conductive rubber member 41 are concavely contracted, to come into contact with the second current output member 47. The second current output member 47 outputs a current output from the fourth conductive rubber member 41. The current value output from the second current output member 47 is a current value changed while a predetermined potential applied to the fourth conductive rubber member 41 passes based on the fourth conductive rubber member 41. The control unit (not shown) recognizes a pressed point and a press strength through the current value output from the second current output member 47, and extracts a second data corresponding to the corresponding pressed point and press strength from the memory unit and inputs the extracted second data.

The control unit (not shown) may be designed such that when the control unit (not shown) recognizes a pressed point and a press strength according to the contact between the fourth conductive rubber member 41 and the second current output member 47, a voltage value output from the second voltage output member 48 according to the contact between the second voltage output member 48 and the fourth conductive rubber member 41 is ignored.

In order to prevent the fourth conductive rubber member 41 from easily coming into contact with the second current output member 47, a non-conductive member (not shown) may be inserted between the fourth conductive rubber member 41 and the second current output member 47, or the second current output member 47 may be installed lower than the second substrate 49 on the second substrate 49 for preventing the fourth conductive rubber member 41 from easily coming into contact with the second current output member 47, not completely preventing from easily coming into contact with the second current output member 47.

As described above, when the non-conductive member (not shown) is inserted between the fourth conductive rubber member 41 and the second current output member 47 or the second current output member 47 is formed to be lower than the second substrate 49, the fourth conductive rubber member 41 does not easily come into contact with the second current output member 47, so that a contact point or a pressed point and a press strength can be recognized according to a power applied to the second voltage output member 48 and a first data or a second data corresponding to the recognized contact point or the recognized pressed point and press strength may be input through a processing by the control unit (not shown).

For example, when a user presses the second voltage output member 48 with a power smaller than a power applied to the second voltage output member 48 such that the fourth conductive rubber member 41 is bent to come into contact with the second current output member 47, the second voltage output member 48 comes into contact with the fourth conductive rubber member 41 to output a voltage value output from the fourth conductive rubber member 41. The control unit (not shown) recognizes a contact point based on the voltage value output from the second voltage output member 48 and extracts a first data corresponding to the contact point from the memory unit and inputs the extracted first data. When a user presses the second voltage output member 48 with a power smaller than a power applied to the second voltage output member 48 such that the fourth conductive rubber member 41 is bent to comes into contact with the second current output member 47, the fourth conductive rubber member 41 does not come into contact with the second current output member 47.

When a user presses the second voltage output member 48 with a power larger than a power applied to the second voltage output member 48 such that the fourth conductive rubber member 41 is bent to come into contact with the second current output member 47, the second voltage output member 48 and the fourth conductive rubber member 41 are contracted to comes into contact with the second current output member 47, and the second current output member 47 outputs a current value changed while a predetermined potential applied to the fourth conductive rubber member 41 passes through the fourth conductive rubber member 41. The current value output from the second current output member 47 is a current changed while a predetermined potential value applied to the fourth conductive rubber member 41 passes through the fourth conductive rubber member 41. The control unit (not shown) recognizes a pressed point and a press strength based on the current value output from the second current output member 47 and extracts a second data corresponding to the recognized pressed point and press strength from the memory unit and inputs the extracted second data. A degree of the contact between the fourth conductive rubber member 41 and the second current output member 47 is different depending on a degree of the concave contraction of the fourth conductive rubber member 41, and a current value output from the second current output member 47 is different depending on a degree of the contact between the fourth conductive rubber member 41 and the second current output member 47. The control unit (not shown) may perform a multi-stage input including at least two stages for inputting different second data depending on a current value output from the second current output member 47. When the control unit (not shown) recognizes a pressed point and a press strength based on a current value output from the second current output member 47, it is designed such that a voltage value output due to the contact between the second voltage output member 48 and the fourth conductive rubber member 41 is ignored.

A non-conductive member (not shown) may be inserted between the fourth conductive rubber member 41 and the second current output member 47 or the second current output member 47 is installed lower than the second substrate 49, so that the fourth conductive rubber member 41 may be prevented from easily coming into contact with the second current output member 47.

In the above, the case where the non-conductive member (not shown) may be inserted between the fourth conductive rubber member 41 and the second current output member 47 or the second current output member 47 is installed lower than the second substrate 49 has been described. However, by changing a material of the fourth conductive rubber member 41 such that a strength of a power capable of concavely contracting the fourth conductive rubber member 41 becomes large, it is possible to prevent the fourth conductive rubber member 41 from easily coming into contact with the second current output member 47. In addition to the aforementioned example, it is possible to prevent the fourth conductive rubber member 41 from easily coming into contact with the second current output member 47 through various methods.

Hereinafter, a method of inputting data where the second voltage output member 48 contacts the fourth conductive rubber member 41 so the second voltage output member 48 does not output a voltage value output from the fourth conductive rubber member 41 will be described in detail.

When a specific point of the second voltage output member 48 is pressed, the second voltage output member 48 and the fourth conductive rubber member 41 are concavely contracted, to come into contact with the second current output member 47. When the fourth conductive rubber member 41 contacts the second current output member 47, the second current output member 47 outputs a current value output from the fourth conductive rubber member 41. When the current value output from the second current output member 47 is smaller than a set current value, the control unit (not shown) recognizes a contact point and extracts a first data corresponding to the contact point from the memory unit and input the extracted first data. When the current value output from the second current output member 47 is larger than the set current value, the control unit (not shown) recognizes a pressed point and a press strength and extracts a second data corresponding to the pressed point and press strength from the memory unit and input the extracted second data. When the current value output from the second current output member 47 is larger than the set current value, the control unit (not shown) may perform a multi-stage input including at least two stages for inputting different second data depending on the current value output from the second current output member 47.

In the above, the case of the application of a predetermined voltage to the fourth conductive rubber member 41 has been described, but a predetermined voltage may be applied to the second voltage output member 48.

For example, when a voltage with a predetermined potential value is applied to the second voltage output member 48 and a specific point of the second voltage output member 48 is pressed, the second voltage output member 48 and the fourth conductive rubber member 41 are concavely contracted to contact the second current output member 47, the predetermined potential value applied to the second voltage output member 48 is changed while passing through the fourth conductive rubber member 41, and the second current output member 47 outputs the current value changed while the potential passes through the fourth conductive rubber member 41. The control unit (not shown) recognizes a contact point, a pressed point, and an a press strength based on the current value output from the second current output member 47, and extracts a first data or a second data corresponding to the contact point or the pressed point and the press strength from the memory unit and inputs the extracted first data or second data. In this case, when the current value output from the second current output member 47 is smaller than the set current value, the control unit (not shown) recognizes the contact point, and when the current value output from the second current output member 47 is larger than the set current value, the control unit (not shown) recognizes the pressed point and the press strength. Accordingly, the control unit (not shown) can extract the first data corresponding to the contact point or the second data corresponding to the pressed point and press strength from the memory unit and input the extracted first data or second data.

Further, a voltage with a predetermined potential value may be applied to the second current output member 47.

For example, when a voltage with a predetermined potential value is applied to the second current output member 47 and a specific point of the second voltage output member 48 is pressed, the second voltage output member 48 and the fourth conductive rubber member 41 are concavely contracted to come into contact with the second current output member 47. When the fourth conductive rubber member 41 is concavely contracted to come into contact with the second current output member 47, a predetermined voltage value applied to the second current output member 47 is changed and output. The control unit (not shown) recognizes a contact point or a pressed point and a press strength based on the output voltage value, and extracts data corresponding to the contact point or the pressed point and the press strength and inputs the extracted data. In this case, a degree of the contact of the fourth conductive rubber member 41 to the second current output member according to the concave contraction of the fourth conductive rubber member 41 is changed depending on a power applied to the second voltage output member 48 and thus a range of a change of the voltage value applied to the second current output member 47 is changed. The control unit (not shown) may recognize the press strength based on the voltage value output from the second current output member 47 according to the power applied to the second voltage output member 48. In the above, the output of the voltage value from the second current output member 47 has been described, but the control unit (not shown) may recognize a contact point or a pressed point and a press strength based on the current value output from the second current output member 47.

Hereinafter, a method of inputting data where the fourth conductive rubber member 41 is formed of a combination of conductive rubber and carbon will be described in detail.

The fourth conductive rubber member 41 may include a single layer formed of a combination of conductive rubber and carbon or include the conductive rubber layer 44 made of conductive rubber and the carbon layer 42 made of carbon film. The conductive rubber layer 44 and the carbon layer 42 of the fourth conductive rubber member 41 may be integrally formed with various conventional methods, such as a double injection molding, or separately formed and then coupled to each other.

The method of inputting data when the fourth conductive rubber member 41 includes the single layer formed of a combination of conductive rubber and carbon is identical to that in the case where the fourth conductive rubber member 41 includes the conductive rubber layer 44 only or the carbon layer 42 only, so its detailed description will be omitted for convenience's sake.

Hereinafter, a method of inputting data where the fourth conductive rubber member 41 includes the conductive rubber layer 44 made of conductive rubber and the carbon layer 42 made of a carbon film will be described in detail.

The second voltage input line 43 for applying a voltage having a predetermined potential value and the second voltage output line 45 for outputting a voltage are connected to one end of the conductive rubber layer 44 of the fourth conductive rubber member 41.

The second current output member 47 is disposed on a lower side of the fourth conductive rubber member 41 and the second voltage output member 48 is disposed on an upper side of the fourth conductive rubber member 41. The conductive rubber layer 44 of the fourth conductive rubber member 41 is disposed at an opposite side of the second voltage output member 48.

When a specific point of the second voltage output member 48 is pressed, the specific points of the second voltage output member 48 and the fourth conductive rubber member 41 are concavely contracted, to come into contact with the second current output member 47. When the fourth conductive rubber member 41 contacts the second current output member 47, a current value change while the predetermined potential value applied to the conductive rubber layer 44 of the fourth conductive rubber member 41 passes through the carbon layer 42 of the fourth conductive rubber member 41 is output from the second current output member 47. A degree of the change of the voltage applied to the conductive rubber layer 44 during the passing through the carbon layer 42 is different depending on a strength of a power applied to the second voltage output member 48 and a current value output from the second current output member 47 is changed. When the current value output from the second current output member 47 is smaller than a set current value, the control unit (not shown) recognizes a contact point based on a voltage value output from the second voltage output member 48 and extracts a first data corresponding to the contact point from the memory unit and inputs the extracted first data. When the current value output from the second current output member 47 is larger than the set current value, the control unit (not shown) ignores a voltage value output from the second voltage output member 48, recognizes a pressed point and a press strength based on the current value output from the second current output member 47, and extracts a second data corresponding to the pressed point and press strength from the memory unit and inputs the extracted second data.

In a case where the fourth conductive rubber member 41 includes the conductive rubber layer 44 and the carbon layer 42, a non-conductive member (not shown) may be inserted between the fourth conductive rubber member 41 and the second current output member 47, or the second current output member 47 may be installed lower than the second substrate 49 on the second substrate 49, so that the fourth conductive rubber member 41 can be prevented from easily coming into contact with the second current output member 47. A method of inputting data in the case where the non-conductive member (not shown) is inserted between the fourth conductive rubber member 41 and the second current output member 47 or where the second current output member 47 may be installed lower than the second substrate 49 has been already described, so its description will be omitted for convenience's sake.

Further, an insulation layer (not shown) may be inserted between the conductive rubber layer 44 and the carbon layer 42 of the fourth conductive rubber member 41. The insulation layer (not shown) does not prevent a predetermined voltage applied to the conductive rubber layer 44 from flowing through the carbon layer 42, but serves to prevent a predetermined voltage applied to the conductive rubber layer 44 from flowing through the carbon layer 42 before a power larger than a certain level is applied to the second voltage output member 48 and to make a predetermined voltage applied to the conductive rubber layer 44 flow through the carbon layer 42 when a power larger than a certain level is applied to the second voltage output member 48.

For example, when a power smaller than a certain level is applied to a specific point of the second voltage output member 48, a voltage applied to the conductive rubber layer 44 of the fourth conductive rubber member 41 is output from the second voltage output member 48, and the control unit (not shown) recognizes a contact point based on the voltage output from the second voltage output member 48 and extracts a first data corresponding to the contact point from the memory unit and inputs the extracted first data. In this case, the voltage applied to the conductive rubber layer 44 of the fourth conductive rubber member 41 is prevented from flowing through the carbon layer 42 of the fourth conductive rubber member 41 due to the insulation layer (not shown).

When a power larger than the certain level is applied to the specific point of the second voltage output member 48, the voltage applied to the conductive rubber layer 44 of the fourth conductive rubber member 41 is changed while passing through the insulation layer (not shown) and the carbon layer 42 and the second current output member 47 outputs a current value changed while the voltage applied to the conductive rubber layer 44 of the fourth conductive rubber member passes through the insulation layer (not shown) and the carbon layer 42. The control unit (not shown) recognizes a pressed point and a press strength based on the current value output from the second current output member 47 and extracts a second data corresponding to the pressed point and the press strength from the memory unit and inputs the extracted second data. When the current value changed while the voltage applied to the conductive rubber layer of the fourth conductive rubber member 41 passes through the insulation layer (not shown) and the carbon layer 42 is output from the second current output member 47, the control unit (not shown) ignores the voltage value output from the second voltage output member 48.

A power applied to the second voltage output member 48 by which the voltage applied to the conductive rubber layer 44 of the fourth conductive rubber member 41 flows to the carbon layer 42 passing through the insulation layer (not shown) is different depending on a material, a thickness, and a property of the insulation layer (not shown).

The disposition of the conductive rubber layer 44 and the carbon layer of the fourth conductive rubber member 41 and the disposition of the second voltage output member 48 and the second current output member 47 are not limited to the aforementioned example, and they may be variously disposed if a contact point, a pressed point, and a press strength can be recognized. Further, the case where a predetermined voltage is applied to the conductive rubber layer 44 of the fourth conductive rubber member 41 has been described as the example in the above description, but a predetermined voltage may be applied to the carbon layer 42. A point to which a predetermined voltage is applied is different depending on the disposition of the conductive rubber layer 44 and the carbon layer 42 of the fourth conductive rubber member 41 and the disposition of the second voltage output member 48 and the second current output member 47.

When the fourth conductive rubber member 41 includes the conductive rubber layer 44 and the carbon layer 42, a predetermined voltage may be applied to the second voltage output member 48 or the second current output member 47.

The input of a first data or a second data using the data input apparatus 10 using the conductive rubber member according to the third embodiment of the present invention is to input data assigned to the first indication points or the second indication points as discussed in the first embodiment, and the first indication points may be assigned to the fourth conductive rubber member 41 and the second indication points may be assigned to the second current output member 47.

The data input apparatus 10 using the conductive rubber member according to the third embodiment of the present invention may further include various elements in addition to the aforementioned elements or omits some of the aforementioned elements.

The data input apparatus using the conductive rubber member according to the first to third embodiments of the present invention may be used together with another input device, such as a mouse, and input various data including characters as well. Further, the data input apparatus using the conductive rubber member according to the first embodiment of the present invention may perform every function, such as a movement of a character or the performance of a command, in a game.

The data input apparatus using the conductive rubber member according to the first to third embodiments of the present invention employs a conductive rubber member which is cheaper than a sensor, such as a haptic sensor, a pressure sensor, and an optical sensor, a touch screen, or a touch pad, so that it is possible to manufacture a data input apparatus with low expenses.

While this invention has been particularly shown and described with reference to the first to third preferred embodiments thereof, these embodiments are provided so that this disclosure will be thorough and complete, and will fully convey the concept of the invention to those skilled in the art. It will be understood by those skilled in the art that various changes in form and details may be made therein without departing from the spirit and scope of the invention as defined by the appended claims.

1. A data input apparatus comprising:
a first conductive rubber member, to one end of which a predetermined voltage is applied and though the other end of which a voltage reduced in proportion to an internal resistance and a length thereof is output;
a first voltage output member disposed in an upper side of the first conductive rubber member with being spaced apart from the first conductive rubber member and coming into contact with the first conductive rubber member according to a press of the first voltage output member at the specific point to output a voltage value of the first conductive rubber member at a specific point, so as to recognize contraction at the specific point of the first conductive rubber member; and
a control unit for recognizing the specific point in the first conductive rubber member based on the voltage value output from the first voltage output member, extracting a first data corresponding to the specific point from a memory unit, and inputting the extracted first data.

2. The data input apparatus of claim 1, further comprising:
a potential setting member disposed on a lower side of the first conductive rubber member and configured to maintain a specific potential value by a voltage input through one end thereof;
a second conductive rubber member disposed in a lower side of the potential setting member and having a resistance value at a specific point changed in proportion to contraction of the second conductive rubber member due to press to a specific point at a corresponding point thereof; and
a first current output member disposed on a lower side of the second conductive rubber member and configured to output a current value changed in proportion to an internal resistance and a thickness of the second conductive rubber member by a potential value applied to the potential setting member while the current passes through the second conductive rubber member,
wherein an insulation member is inserted between the first conductive rubber member and the potential setting member, and
the control unit determines if the current value output from the first current output member is included in a preset range, extracts a second data corresponding to a pressed point for the second conductive rubber member and the set range from the memory unit and inputs the extracted second data.

3. The data input apparatus of claim 1, wherein a plurality of first indication points are arranged in the first conductive rubber member in a longitudinal direction of the first conductive rubber member at a same interval, and when the control unit recognizes a contact at a specific first indication point among the first indication points, the control unit extracts a first data assigned to the specific first indication point from the memory unit and inputs the extracted first data.

4. The data input apparatus of claim 2, wherein a plurality of second indication points are arranged in the second conductive rubber member in a longitudinal direction of the second conductive rubber member at a same interval, and when control unit recognizes a press for a specific second indication point among the second indication points, the control unit extracts a second data assigned to the specific second indication point from the memory unit and inputs the extracted first data.

5. The data input apparatus of claim 3, wherein the first conductive rubber member, the first voltage output member, the potential setting member, and the second conductive rubber member are stacked in a ring shape on the first current output member, and the first indication points and the second indication points are radially spaced from each other based on a center of the ring shape.

6. The data input apparatus of claim 5, wherein the number and positions of the first indication points are set to be identical to or different from those of the second indication points.

7. The data input apparatus of claim 5, wherein a press input at the second indication point enables a multi-stage input including two or more stages based on a range of a current value that is proportional to an increase of a contraction quantity according to a strength of the press.

8. A data input apparatus comprising:
a current input/output member comprising a signal input unit and a plurality of signal output units, the signal input unit and the plurality of signal output units being separately formed on an upper portion thereof;
a third conductive rubber member stacked on an upper portion of the current input/output member and configured to change a resistance value between the input signal unit and the output signal unit corresponding to a pressed point while being contracted due to press from an upper part thereof to change a current value output from the output signal unit; and
a control unit for, when a current value within a set range is applied from the output signal unit, extracting data assigned to the output signal unit corresponding to a pressed point from a memory unit and inputting the extracted data.

9. The data input apparatus of claim 8, wherein the control unit detects press at multiple points of the third conductive rubber member, the control unit recognizes a corresponding position of the output signal unit corresponding to each press and extracts data assigned to each corresponding output signal unit or data according to a combination of the plurality of output signal units from the memory unit and inputs the extracted data.

10. A data input apparatus comprising:
a fourth conductive rubber member having a resistance value changed according to contraction due to press from an upper side thereof at a corresponding point;
a second current output member disposed in a lower side of the fourth conductive rubber member and coming into contact with the fourth conductive rubber member to output a current value output through the fourth conductive rubber member; and
a control unit for comparing a current value output from the second current output member with a set current value to determine a contact point or a pressed point or a press strength, extracting a first data or a second data corresponding to the contact point or the pressed point and the press strength from a memory unit, and inputting the extracted first data or second data.

11. The data input apparatus of claim 10, further comprising a second voltage output member disposed in an upper side of the fourth conductive rubber member and coming into contact with the fourth conductive rubber member to output a voltage value output from the fourth conductive rubber member,
wherein the control unit recognizes a contact point based on a voltage value output from the second voltage output member, extracts a first data corresponding to the contact point from the memory unit, and inputs the extracted first data.

12. The data input apparatus of claim 10, wherein the fourth conductive rubber member is made of conductive rubber, a combination of conductive rubber and carbon, or a carbon film.

13. The data input apparatus of claim 11, wherein the second voltage output member has recesses for coupling to the fourth conductive rubber member at a lower part thereof and is shaped like any one among a rectangle, a trapezoid, or an inverted trapezoid.

14. The data input apparatus of claim 10, wherein a member made of a non-conductive material for preventing the fourth conductive rubber member from easily coming into contact with the second current output member is inserted between the fourth conductive rubber member and the second current output member.

15. The data input apparatus of claim 12, wherein the fourth conductive rubber member formed of a combination of the conductive rubber and the carbon includes a single layer formed of a combination of the conductive rubber and the carbon or includes a conductive rubber layer made of the conductive rubber and a carbon layer made of carbon.

16. The data input apparatus of claim 15, wherein an insulation layer for allowing current to flow between the conductive rubber layer and the carbon layer when a power equal to or larger than a predetermined range is applied between the conductive rubber layer and the carbon layer included in the fourth conductive rubber member is inserted between the conductive rubber layer and the carbon layer.

17. The data input apparatus of claim 4, wherein the first conductive rubber member, the first voltage output member, the potential setting member, and the second conductive rubber member are stacked in a ring shape on the first current output member, and the first indication points and the second indication points are radially spaced from each other based on a center of the ring shape.

18. The data input apparatus of claim 17, wherein the number and positions of the first indication points are set to be identical to or different from those of the second indication points.

19. The data input apparatus of claim 17, wherein a press input at the second indication point enables a multi-stage input including two or more stages based on a range of a current value that is proportional to an increase of a contraction quantity according to a strength of the press.
